(19) United States
(12) Patent Application Publication
(10) Pub. No.: US 2018/0321970 A1
(43) Pub. Date: Nov. 8, 2018

(54) Controlling Background Activity of an Application Using a Policy

(71) Applicant: Microsoft Technology Licensing, LLC, Redmond, WA (US)

(72) Inventors: Christopher Alan CORTES, Seattle, WA (US); Jason Scott HOLMES, Kirkland, WA (US); Richard Andrew POSPESEL, Kirkland, WA (US); Timothy Michael KURTZMAN, Redmond, WA (US); Stefan WICK, Sammamish, WA (US)

(73) Assignee: Microsoft Technology Licensing, LLC, Redmond, WA (US)

(21) Appl. No.: 15/588,651

(22) Filed: May 7, 2017

(51) Int. Cl. G06F 9/48; G06F 9/50

(52) U.S. Cl. CPC G06F 9/4843; G06F 9/46; G06F 9/4893; G06F 9/5005

(57) ABSTRACT

Described herein is a system for controlling background execution of an application based on a stored policy. The stored policy can be defined by an enterprise administrator. The policy controls an ability of an application to execute in the background. The system includes a background access manager component that, in response to a request to execute in the background received from the application, determines whether or not to allow the application to execute in the background based upon the policy, a user-configured master control policy and/or relevant system state.

### BACKGROUND

A computer user may be unaware that an application is running in the background since no visual element(s) of the application are presented to the user. An application running in the background further can be doing work that does not directly benefit a current workflow of the user. This can lead to user frustration as computing resources are being utilized for an application of which the user is unaware.

### SUMMARY

Described herein is a system for controlling background execution of an application based on a stored policy. The system includes a computer comprising a processor and a memory, the memory including a policy store configured to store a policy for controlling an ability of an application to execute in the background. The memory further includes a background access manager component configured to, in response to a request to execute in the background received from the application, determine whether or not to allow the application to execute in the background based upon the policy. The background access manager component is further configured to allow the application to execute in the background when the policy identifies the application as allowed to execute in the background.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a functional block diagram that illustrates a system for controlling background execution of an application based on a stored policy.

FIG. 2 illustrates an exemplary method of controlling background execution of an application based on a stored policy.

FIG. 3 is a functional block diagram that illustrates an exemplary computing system.

### DETAILED DESCRIPTION

Various technologies pertaining to controlling background execution of an application based on a stored policy are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

The subject disclosure supports various products and processes that perform, or are configured to perform, various actions regarding controlling background execution of an application based on a stored policy. What follows are one or more exemplary systems and methods.

Aspects of the subject disclosure pertain to the technical problem of controlling background execution of an application on a particular computing device. The technical features associated with addressing this problem involve receiving at the particular device, from a remote entity, a policy controlling background execution of an application, and, applying the policy when determining whether or not to allow a particular application to execute in the background on the particular computing device. Accordingly, aspects of these technical features exhibit technical effects of more efficiently, effectively and securely utilizing computer resources.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

As used herein, the terms “component” and “system,” as well as various forms thereof (e.g., components, systems, sub-systems, etc.) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. Further, as used herein, the term “exemplary” is intended to mean serving as an illustration or example of something, and is not intended to indicate a preference.

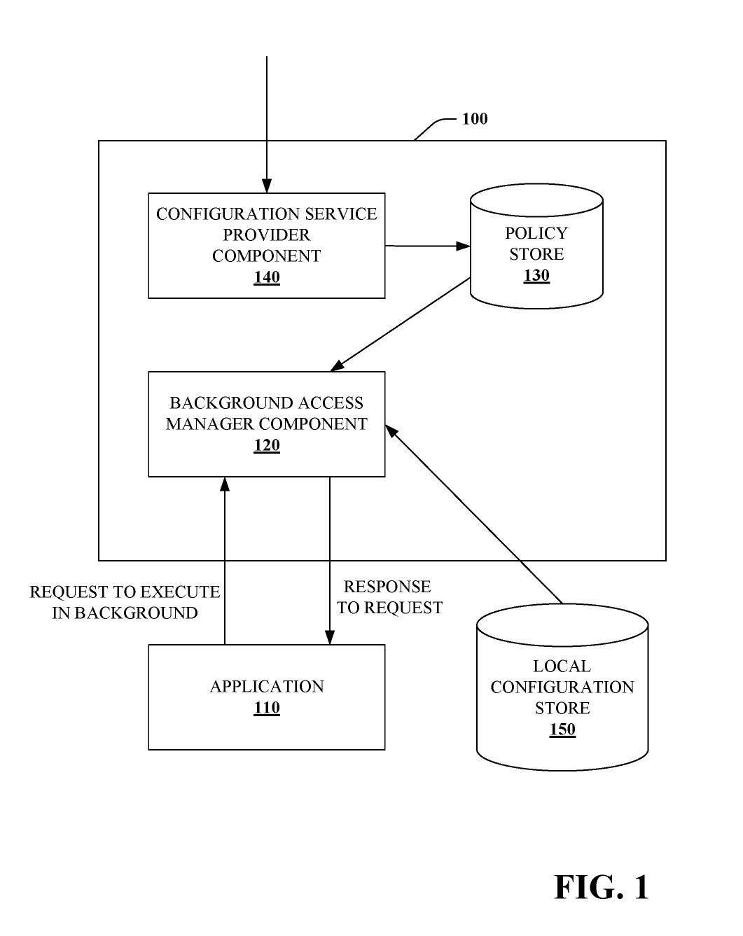

Referring to FIG. 1, a system for controlling background execution of an application based on a stored policy 100 is illustrated. The system 100 can facilitate a level of control by an enterprise over application(s) 110 that are able to run in the background on a particular computing device.

Application(s) running in the foreground provide visibility of the application in a user interface that allows a user to know that the application is running. However, for application(s) running in the background, there are generally no visual element(s) of the application so the user may not be aware that the application is running in the background. While executing in the background, the application may be performing work that does not have direct benefit to a current workflow of the user. Reducing and/or removing an application's ability to run in the background can lead to a reduction in resource usage for non-essential work, and also limits the possibility of recording and/or delivering private information when it is non-essential to do so.

The system 100 allows flexibility in configuring policy(ies) for controlling background execution of application(s) on a set of computing device(s). In one embodiment, a policy can provide for one or more specified applications to always be permitted to run in the background (e.g., regardless of user-configured setting). In one embodiment, a policy can provide for one or more specified applications to be controlled by a user-configured setting on a particular computing device. In one embodiment, a policy can provide for one or more specified applications to never be permitted to run in the background (e.g., regardless of user-configured setting).

The policy approach of the system 100 advantageously distinguishes over a system in which a particular application is entirely blocked (e.g., restricted) from being installed on the particular computing device. The system 100 allows for a policy which allows for the particular application to be installed on the particular computing device and able to run in the foreground, but does not have the ability to run in the background.

Additionally, quarantine of a particular application determined to be spyware and/or malware can restrict the ability of the particular application to run. The system 100 however allows for flexibility in a situation in which a particular application is known (e.g., determined) to not be malicious, but is known to use resource(s) and/or access private/personally identifiable information at a time that is not required for the application to complete the application's primary user scenario. For example, to reduce resource consumption and/or block access to sensitive information by background execution, the system 100 allows for a policy which allows for the particular application to run in the foreground (e.g., visible to user), but does not have the ability to run in the background.

The system 100 includes a background access manager component 120 and a policy store 130. The policy store 130 can store one or more policy(ies) for controlling an ability of identified application(s) to execute in the background (e.g., lack of visual element(s) tied to running application process). The policy(ies) can be received via a configuration service provider component 140.

In one embodiment, the policy(ies) are received from a remote computer system (e.g., cloud-based service) as part of a subscription service. In one embodiment, the policy(ies) are received from a remote computer system associated with an enterprise and authored by a system administrator.

In one embodiment, enterprise user(s) can define policy(ies) to be applied to a set of computing devices using a group policy and/or mobile device management authoring and deployment tool (e.g., Group Policy Manager, Microsoft Intune® and the like.). In one embodiment, the policy(ies) can be delivered to the configuration service provider component 140 through the Group Policy device management protocol. In one embodiment, the policy(ies) can be delivered to the configuration service provider component 140 through the Open Mobile Alliance's Mobile Device Management protocol.

In one embodiment, the policy(ies) are received based upon information associated a user of a computing device associated with the system 100. Policy(ies) can be defined (and applied), for example, for a particular class of user (e.g., employee of enterprise), location of computing device (e.g., on campus, at an offsite location), connectivity (e.g., accessible via trusted internal network, accessible via an external network, accessible via a virtual private network), connection bandwidth, type of computing device (e.g., personal computer, tablet, mobile phone, game system, augmented reality device, etc.) and the like.

Information can be stored in a policy in any suitable format that identifies a particular application and information for controlling background execution of the particular application. In one embodiment, information can be stored in a semi-colon delimited string of package family names provided as identifiers for a list of application packages.

In one embodiment, one or more policy control(s) are available. For example, a policy stored in the policy store 130 can include a master control policy, a list of applications that are always allowed to run in the background, a list of applications that are never allowed to run in the background and/or a list of applications that can be controlled by the device user rather than the enterprise.

The master control policy controls managed application(s) (e.g., Universal Windows® application(s)) on a particular computing device. For example, there can be three options: (1) always allowed—applications are always allowed to run in the background; (2) controlled by user—the device user is given the ability to control this behavior through a user interface; and, (3) never allowed—applications are never allowed to run in the background.

In one embodiment, one or more application(s) can be excluded from the master control policy and have a different policy applied to them through the list of applications that are always allowed to run in the background, the list of applications that are never allowed to run in the background and/or the list of applications that can be controlled by the device user rather than the enterprise.

The list of applications that are always allowed to run in the background identifies application(s) that will be allowed to always run in the background, regardless of a setting in the master control policy. In one embodiment, the list comprises a semi-colon delimited string of Package Family Names provided as identifiers for a list of application packages. The applications within these packages will be allowed to always run in the background, regardless of the setting of the master control policy.

The list of applications that are never allowed to run in the background identifies application(s) that will never be allowed to run in the background, regardless of a setting in the master control policy. In one embodiment, the list comprises a semi-colon delimited string of Package Family Names provided as the identifiers for a list of application packages. The applications within these packages will be never be allowed to run in the background, regardless of the setting of the master control policy.

The list of applications that can be controlled by the device user rather than the enterprise identifies application(s) that have control(s) provided to the user of the device, who can then select which option they want (e.g., allow or block). In one embodiment, the list comprises a semi-colon delimited string of Package Family Names provided as identifiers for a list of application packages. The applications within these packages will have controls provided to the user of the device, who can then select which option they want, regardless of the setting of the master control policy.

The configuration service provider component 140 receives policy(ies) and provides the policy(ies) to the policy store 130. In one embodiment, each client device includes a configuration service provider component 140 that receive messages including policy(ies), for example, from policy management tools and applies those policy(ies) to the device. In one embodiment, when a policy message is received, the message is read and immediately applied to the device, without the need for a reboot. In one embodiment, when a policy is applied, user settings are placed into a locked state to ensure the enterprise-enforced option maintains set.

In one embodiment, the enterprise settings are maintained in a separate location than user-defined settings stored in a local configuration store 150. This is to ensure user settings are maintained in the event that the enterprise policy is removed.

The background access manager component 120 can determine an appropriate level of access (e.g., allowed, blocked, determined by user configuration setting(s), etc.) to running in the background provided to each application at each time the application requests to run in the background (e.g., during normal execution of application(s)). In one embodiment, an application can request access to run in the background during registration of trigger(s) that will wake the application up in the background. A trigger is a system event that can fire and activate an application, even if the application isn't running. In one embodiment, trigger(s) can be a time trigger, a push notification trigger, a socket activity trigger, a toast notification action trigger, a toast notification history changed trigger, a user notification changed trigger, a location trigger, a contact store notification trigger, an appointment store notification trigger, an email store notification trigger, a cached file change notification trigger, a peripheral device use trigger, a peripheral device connection trigger, a peripheral device servicing trigger, a peripheral device watcher trigger, a Bluetooth advertisement watcher trigger, a Bluetooth advertisement publisher trigger, a Bluetooth Generic Attribute Profile (Gatt) characteristic notification trigger, a Bluetooth Gatt Service provider trigger, a user presence trigger, an Internet available trigger, a network state change trigger, a time zone change trigger, a power state change trigger, an application trigger, a media processing trigger, a content prefetch trigger, a maintenance trigger, a radio frequency communication (rf comm) connection trigger, a mobile broadband device service notification trigger, a mobile broadband pin lock state change trigger, a mobile broadband registration state change trigger, a mobile broadband radio state change trigger, a network operator notification trigger, a network operator hotspot authentication trigger, an secondary authentication factor authentication trigger, a sensor data threshold trigger, a short message service (SMS) message received trigger and/or a storage library content changed trigger.

In one embodiment, an application can request access to run in the background at a time that an application is triggered to be activated in the background (e.g., due to a system condition). In one embodiment, an application can request access to run in the background at a time an application is active in the foreground and is attempting to be moved into the background (e.g., while requesting additional time to run in the background).

At one or more of these times, the background access manager component 120 can check the stored policy (e.g., enterprise settings) (e.g., policy store), the master control policy (e.g., user settings) and/or any other relevant system state (e.g., screen status, user session status, etc.) to determine a particular application's background access status. Based upon the stored policy, the master control policy and/or other relevant system state, the background access manager component 120 can determine whether or not to permit the particular application to execute in the background.

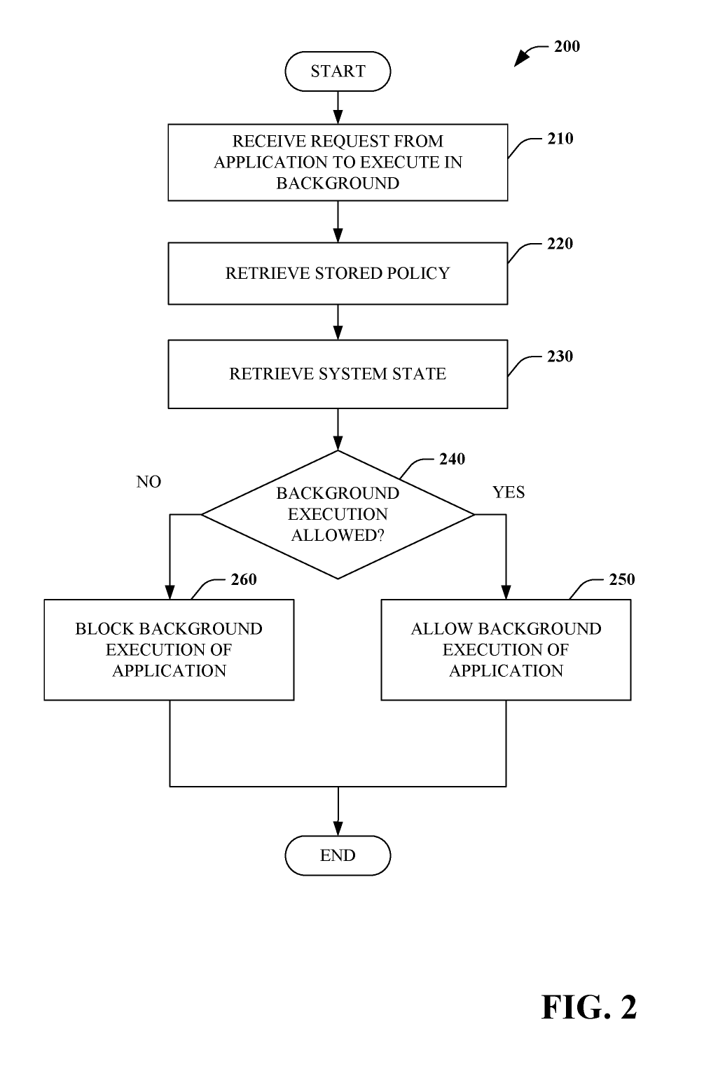

FIG. 2 illustrate an exemplary methodology relating to controlling background execution of an application based on a stored policy. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring to FIG. 2, a method of controlling background execution of an application based on a stored policy 200 is illustrated. The stored policy can control an ability of identified application(s) to execute in the background (e.g., lack of visual element(s) tied to running application process).

At 210, a request to execute in the background is received from an application. The request can be received, for example, during registration of trigger(s) that will wake the application up in the background, at a time that the application is triggered to be activated in the background (e.g., due to a system condition) and/at a time the application is active in the foreground and is attempting to be moved into the background (e.g., while requesting additional time to run in the background).

At 220, a stored policy is retrieved. In one embodiment, the policy can be retrieved from the policy store 130 and can include a master control policy, a list of applications that are always allowed to run in the background, a list of applications that are never allowed to run in the background and/or a list of applications that can be controlled by the device user rather than the enterprise. In one embodiment, user-defined settings, for example, stored in the local configuration store 150 are also retrieved.

At 230, system state is retrieved. For example, the system state can include screen status, user session status, etc.

At 240, a determination is made as to whether to allow background execution of the application based upon the stored policy, the retrieved user-defined settings and/or the retrieved system state. In one embodiment, the retrieved policy can provide for one or more specified applications to always be permitted to run in the background (e.g., regardless of setting(s) in the master control policy). In one embodiment, the policy can provide for one or more specified applications to be controlled by a user-configured setting on a particular computing device (e.g., set forth in the user-configured master control policy). In one embodiment, the policy can provide for one or more specified applications to never be permitted to run in the background (e.g., regardless of setting(s) in the user-configured master control policy).

If the determination at 240 is YES, at 250, the application is allowed to execute in the background. If the determination at 250 is NO, at 260, the application is blocked from executing in the background.

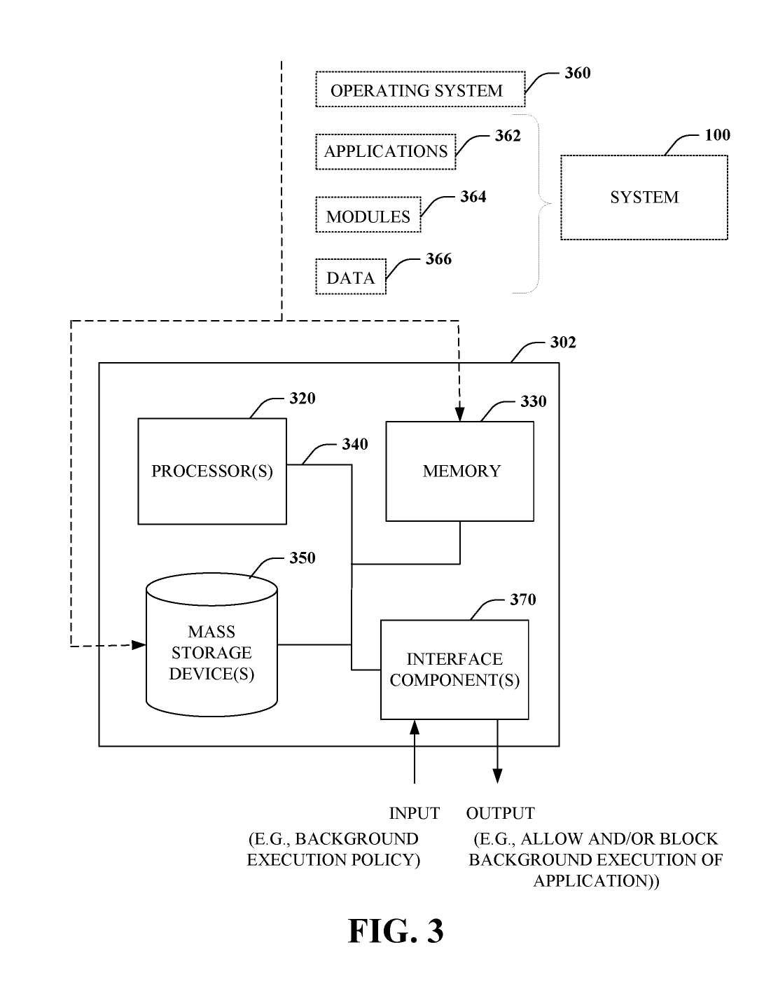

With reference to FIG. 3, illustrated is an example general-purpose computer or computing device 302 (e.g., mobile phone, desktop, laptop, tablet, watch, server, hand-held, programmable consumer or industrial electronics, set-top box, game system, compute node, etc.). For instance, the computing device 302 may be used in a system for controlling background execution of an application based on a stored policy 100.

The computer 302 includes one or more processor(s) 320, memory 330, system bus 340, mass storage device(s) 350, and one or more interface components 370. The system bus 340 communicatively couples at least the above system constituents. However, it is to be appreciated that in its simplest form the computer 302 can include one or more processors 320 coupled to memory 330 that execute various computer executable actions, instructions, and or components stored in memory 330. The instructions may be, for instance, instructions for implementing functionality described as being carried out by one or more components discussed above or instructions for implementing one or more of the methods described above.

The processor(s) 320 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 320 may also be implemented as a combination of computing devices, for example a combination of a DSP and a microprocessor, a plurality of microprocessors, multi-core processors, one or more microprocessors in conjunction with a DSP core, or any other such configuration. In one embodiment, the processor(s) 320 can be a graphics processor.

The computer 302 can include or otherwise interact with a variety of computer-readable media to facilitate control of the computer 302 to implement one or more aspects of the claimed subject matter. The computer-readable media can be any available media that can be accessed by the computer 302 and includes volatile and nonvolatile media, and removable and non-removable media. Computer-readable media can comprise two distinct and mutually exclusive types, namely computer storage media and communication media.

Computer storage media includes volatile and nonvolatile, removable and non-removable media implemented in any method or technology for storage of information such as computer-readable instructions, data structures, program modules, or other data. Computer storage media includes storage devices such as memory devices (e.g., random access memory (RAM), read-only memory (ROM), electrically erasable programmable read-only memory (EEPROM), etc.), magnetic storage devices (e.g., hard disk, floppy disk, cassettes, tape, etc.), optical disks (e.g., compact disk (CD), digital versatile disk (DVD), etc.), and solid state devices (e.g., solid state drive (SSD), flash memory drive (e.g., card, stick, key drive) etc.), or any other like mediums that store, as opposed to transmit or communicate, the desired information accessible by the computer 302. Accordingly, computer storage media excludes modulated data signals as well as that described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Memory 330 and mass storage device(s) 350 are examples of computer-readable storage media. Depending on the exact configuration and type of computing device, memory 330 may be volatile (e.g., RAM), non-volatile (e.g., ROM, flash memory, etc.) or some combination of the two. By way of example, the basic input/output system (BIOS), including basic routines to transfer information between elements within the computer 302, such as during start-up, can be stored in nonvolatile memory, while volatile memory can act as external cache memory to facilitate processing by the processor(s) 320, among other things.

Mass storage device(s) 350 includes removable/non-removable, volatile/non-volatile computer storage media for storage of large amounts of data relative to the memory 330. For example, mass storage device(s) 350 includes, but is not limited to, one or more devices such as a magnetic or optical disk drive, floppy disk drive, flash memory, solid-state drive, or memory stick.

Memory 330 and mass storage device(s) 350 can include, or have stored therein, operating system 360, one or more applications 362, one or more program modules 364, and data 366. The operating system 360 acts to control and allocate resources of the computer 302. Applications 362 include one or both of system and application software and can exploit management of resources by the operating system 360 through program modules 364 and data 366 stored in memory 330 and/or mass storage device (s) 350 to perform one or more actions. Accordingly, applications 362 can turn a general-purpose computer 302 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, system 100 or portions thereof, can be, or form part, of an application 362, and include one or more modules 364 and data 366 stored in memory and/or mass storage device(s) 350 whose functionality can be realized when executed by one or more processor(s) 320.

In accordance with one particular embodiment, the processor(s) 320 can correspond to a system on a chip (SOC) or like architecture including, or in other words integrating, both hardware and software on a single integrated circuit substrate. Here, the processor(s) 320 can include one or more processors as well as memory at least similar to processor(s) 320 and memory 330, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the system 100 and/or associated functionality can be embedded within hardware in a SOC architecture.

The computer 302 also includes one or more interface components 370 that are communicatively coupled to the system bus 340 and facilitate interaction with the computer 302. By way of example, the interface component 370 can be a port (e.g., serial, parallel, PCMCIA, USB, FireWire, etc.) or an interface card (e.g., sound, video, etc.) or the like. In one example implementation, the interface component 370 can be embodied as a user input/output interface to enable a user to enter commands and information into the computer 302, for instance by way of one or more gestures or voice input, through one or more input devices (e.g., pointing device such as a mouse, trackball, stylus, touch pad, keyboard, microphone, joystick, game pad, satellite dish, scanner, camera, other computer, etc.). In another example implementation, the interface component 370 can be embodied as an output peripheral interface to supply output to displays (e.g., LCD, LED, plasma, etc.), speakers, printers, and/or other computers, among other things. Still further yet, the interface component 370 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A system for controlling background execution of an application based on a stored policy:
a computer comprising a processor and a memory, the memory comprising:
a policy store configured to store a policy for controlling an ability of an application to execute in the background; and
a background access manager component configured to, in response to a request to execute in the background received from the application, determine whether or not to allow the application to execute in the background based upon the policy, the background access manager component further configured to allow the application to execute in the background when the policy identifies the application as allowed to execute in the background.

2. The system of claim 1, further comprising a configuration service provider component configured to receive the policy from a remote computer, the configuration service provider component further configured to store the received policy in the policy store.

3. The system of claim 1, wherein the policy comprises a master control policy that stores information regarding managed applications on the computer, the background access manager component further configured to determine whether or not to allow the application to execute in the background based upon the master control policy.

4. The system of claim 1, wherein the policy stores information regarding at least one of a first group of one or more applications that are always allowed to run in the background, a second group of one or more applications that are never allowed to run in the background, or a third group of zero or more applications that are user configured for background execution.

5. The system of claim 4, wherein the information regarding the first group, the second group or the third group controls background execution of a particular application over information stored in a master control policy regarding the particular application.

6. The system of claim 1, wherein a local configuration store storing user-defined settings is stored separately from the policy.

7. The system of claim 1, wherein the policy is applied based on at least one of a particular class of user, a location of the computer, connectivity of the computer, a connection bandwidth or a type of computer.

8. The system of claim 1, wherein the request to execute in the background is received from the application during registration of one or more triggers that will wake the application up in the background.

9. The system of claim 8, wherein the one or more triggers comprise at least one of a time trigger, a push notification trigger, a socket activity trigger, a toast notification action trigger, a toast notification history changed trigger, a user notification changed trigger, a location trigger, a contact store notification trigger, an appointment store notification trigger, an email store notification trigger, a cached file change notification trigger, a peripheral device use trigger, a peripheral device connection trigger, a peripheral device servicing trigger, a peripheral device watcher trigger, a Bluetooth advertisement watcher trigger, a Bluetooth advertisement publisher trigger, a Bluetooth generic attribute profile (Gatt) characteristic notification trigger, a Bluetooth generic attribute profile (Gatt) Service provider trigger, a user presence trigger, an Internet available trigger, a network state change trigger, a time zone change trigger, a power state change trigger, an application trigger, a media processing trigger, a content prefetch trigger, a maintenance trigger, a radio frequency communication (rf comm) connection trigger, a mobile broadband device service notification trigger, a mobile broadband pin lock state change trigger, a mobile broadband registration state change trigger, a mobile broadband radio state change trigger, a network operator notification trigger, a network operator hotspot authentication trigger, an secondary authentication factor authentication trigger, a sensor data threshold trigger, a short message service (SMS) message received trigger or a storage library content changed trigger.

10. The system of claim 1, wherein the request to execute in the background is received from the application in response to a particular trigger being activated.

11. The system of claim 1, wherein the request to execute in the background is received from the application at a time the application is active in the foreground and is attempting to be moved into the background.

12. The system of claim 1, wherein the background access manager component is further configured to determine whether or not to allow the application to execute in the background based upon system state associated with the computer.

13. A method of controlling background execution of an application based on a stored policy, comprising:
in response to receiving a request from the application to execute in the background, retrieving the stored policy;
determining whether or not to allow the application to execute in the background based upon the retrieved stored policy; and
when the policy identifies the application as allowed to execute in the background, allowing the application to execute in the background.

14. The method of claim 13, wherein the policy comprises a master control policy that stores information regarding managed applications on the computer.

15. The method of claim 13, wherein the policy stores information regarding at least one of a first group of one or more applications that are always allowed to run in the background, a second group of one or more applications that are never allowed to run in the background, or a third group of one or more applications that are user configured for background execution.

16. The method of claim 15, wherein the information regarding the first group, the second group or the third group controls background execution of a particular application over information stored in a master control policy regarding the particular application.

17. A computer storage media storing computer-readable instructions that when executed cause a computing device to:
in response to receiving a request from the application to execute in the background, retrieve a stored policy;
determine whether or not to allow an application to execute in the background based upon the retrieved stored policy; and
when the policy identifies the application as allowed to execute in the background, allow the application to execute in the background.

18. The computer storage media of claim 17, wherein the policy comprises a master control policy that stores information regarding managed applications on the computing device.

19. The computer storage media of claim 17, wherein the policy stores information regarding at least one of a first group of one or more applications that are always allowed to run in the background, a second group of one or more applications that are never allowed to run in the background, or a third group of one or more applications that are user configured for background execution.

20. The computer storage media of claim 19, wherein the information regarding at least one of the first group, the second group or the third group controls background execution of a particular application over information stored in a master control policy regarding the particular application.
